(19) United States
(12) Patent Application Publication
(10) Pub. No.: US 2009/0201992 A1
(43) Pub. Date: Aug. 13, 2009

(54) METHOD AND APPARATUS FOR ENCODING AND DECODING HOPPING DEFAULT VIEW FOR MULTIPLE CAMERAS SYSTEM

(76) Inventors: Jeong-Il Seo, Daejon (KR); Dong-Gyu Sim, Seoul (KR); Wook-Joong Kim, Daejon (KR); Kyu-Heon Kim, Daejon (KR); Kyeong-Ok Kang, Daejon (KR); Jin-Woo Hong, Daejon (KR); Seoung-Jun Oh, Gyeonggi-do (KR); Yung-Lyul Lee, Seoul (KR); Chang-Beom Ahn, Seoul (KR); Sea-Nae Park, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/089,401

(22) PCT Filed: Oct. 4, 2006
(86) PCT No.: PCT/KR06/04000

§ 371 Date: Jul. 31, 2008

(30) Foreign Application Priority Data
Oct. 7, 2005 (KR) 10-2005-0094418

(51) Int. Cl. H04N 11/02

(52) U.S. Cl. 375/240.16; 375/E07.088; 375/E07.027

(57) ABSTRACT

Provided is a multiple camera system, and more particularly, a method and apparatus for processing hopping default views in an apparatus for encoding/decoding video streams of multiple view positions. The encoding apparatus for the multiple camera system includes an encoder for receiving video signals of multiple view positions, and encoding the video signals based on a predetermined default Group of Pictures (GoP); a default GoP selector for providing the default GoP information to the encoder; and a multiplexer for multiplexing the encoded video signals and sequentially outputting only the default GoP.

### TECHNICAL FIELD

The present invention relates to a multiple camera system; and more particularly, to a method for encoding/decoding a hopping default view in an encoding/decoding apparatus for processing multi-view video stream, and the encoding/decoding apparatus.

### BACKGROUND ART

A multiple camera system refers to a system which acquires video data of a scene from multiple viewpoints, or view positions, and processes the video data of the multiple view positions in the same time duration. Since the multi view video system provides a human being with not only realistic video but also 3D effect, it is applied to many areas.

A multi-view video stream encoding/coding apparatus for encoding/decoding video streams of multiple views in the same time duration individually compresses, transmits, and decompresses video streams generated from respective cameras. The method can be easily realized based on conventional technologies, e.g., Moving Picture Experts Group (MPEG) 1/2/4 or H.261/263/264. However, the conventional technologies have a shortcoming that redundancy between videos which are created by photographing the same scene with a plurality of cameras can not be removed.

Recent technologies suggest a method of effectively compressing video streams of multiple view positions by get red of the redundancy between cameras. However, the method has a shortcoming that it can display a restrictive view with a conventional mono or stereo video apparatus because the encoding is conducted by referring to adjacent video with adjacent camera.

When a view from a camera is determined as a basis view in a conventional mono video apparatus, there is a restriction that the video stream of the camera should be displayed from the start to the end. Likewise, the conventional stereo video apparatus has a restriction that two video streams from two cameras are continuously displayed. No researches suggest a multi-view video system that a basis default view in time can be changed.

### DISCLOSURE

### Technical Problem

It is, therefore, an object of the present invention to provide a method for changing a default view with respect to time when video streams of multiple view positions are compressed, and changing a default view by a content producer suitably for a mono, stereo or view-hopping video encoding/decoding apparatus, and an apparatus therefor.

It is another object of the present invention to provide a view-hopping video apparatus that can not only have a user select a view position but also provide a default view set by a content producer by transmitting an observation direction and position of viewers at a predetermined time, and a method thereof.

### Technical Solution

In accordance with one aspect of the present invention, there is provided an encoding apparatus for a multiple camera system, which includes: an encoder for receiving video signals of multiple view positions, and encoding the video signals based on a predetermined default Group of Pictures (GoP); a default GoP selector for providing the default GoP information to the encoder; and a multiplexer for multiplexing the encoded video signals and sequentially outputting only the default GoP.

In accordance with another aspect of the present invention, there is provided a decoding apparatus for a multiple camera system, which includes: a receiver for sequentially receiving encoded default GoP with no reference to video signals of another view position; a decoder for decoding the received signals; and a display for showing the decoded video signals.

In accordance with another aspect of the present invention, there is provided an encoding apparatus for a multiple camera system, which includes: an encoder for receiving video signals of multiple view positions, and encoding the video signals based on a predetermined GoP and a default stereo GoP; a GoP selector for providing the predetermined default GoP information and the default stereo GoP information to the encoder; and a multiplexer for multiplexing the encoded video signals and sequentially outputting only a default GoP and a default stereo GoP corresponding to the default GoP.

In accordance with another aspect of the present invention, there is provided a decoding apparatus for a multiple camera system, which includes: a receiver for sequentially receiving a default GoP encoded with no reference to video signals of another view position and a default stereo GoP of the same time duration which refers to the default GoP; a decoder for decoding the received signals; and a display for showing stereo video signals based on the decoded signals.

The default GoP is encoded with no reference to video signals of another view position, and it is changed with a GoP of another view position for each predetermined time duration. Also, the default GoP may be predetermined in an encoding apparatus or it may be defined by being transmitted to the encoding apparatus upon receipt of input from the user.

The default stereo GoP may be encoded with reference to a default GoP of the same time duration.

Also, the present invention provides a multiple camera system, which includes an encoder for encoding video signals of multiple view positions from the user; a default encoder which is predetermined or determined as the user inputs data; a multiplexer for multiplexing and outputting the encoded multi-view video signals and default view information; and a view-hopping video playing apparatus for displaying video signals based on the default view information. Herein, the default view is predetermined or set up as the user inputs data and it is changed with a view of another view position for each predetermined time duration.

### ADVANTAGEOUS EFFECTS

The technology of the present invention can set up a default view and view position desired by a content producer or a user adaptively to a mono, stereo, or view-hopping video playing apparatus in a multiple camera system which provides video streams of multiple view positions.

Further, the technology of the present invention has an advantage that it can reconstruct video in a conventional mono video playing apparatus, too, by decoding only a default Group of Pictures (GoP) among the video streams of multiple view positions. The technology of the present invention can also reconstruct video in a conventional stereo video playing apparatus by transmitting and decoding only the default GoP and a default stereo GoP pair. In addition, when the technology of the present invention is applied to a conventional view-hopping video playing apparatus, it is possible to freely select a view position desired by the content producer.

Also, the technology of the present invention can not only provide a view hopping function but also improve video compression efficiency by changing a default view according to time. It can also improve compression efficiency when reference video is compressed by setting up a base camera, a camera which is proper for each time duration, in the multiple camera system.

### DESCRIPTION OF DRAWINGS

The above and other objects and features of the present invention will become apparent from the following description of the preferred embodiments given in conjunction with the accompanying drawings, in which:

FIG. 1 is a view illustrating a method of compressing video streams of multiple view positions in accordance with an embodiment of the present invention;

FIG. 2 is a view showing a Group of Picture (GoP) bitstream created by encoding and compressing video streams of multiple view positions;

FIG. 3 is a block view showing structures of a default view processing apparatus and a mono video playing apparatus in accordance with an embodiment of the present invention;

FIG. 4 is a block view illustrating structures of a stereo video processing apparatus and a stereo video playing apparatus in accordance with an embodiment of the present invention; and

FIG. 5 is a block view describing a view-hopping video processing apparatus and a view-hopping video playing apparatus in accordance with an embodiment of the present invention.

### BEST MODE FOR THE INVENTION

Other objects and aspects of the invention will become apparent from the following description of the embodiments with reference to the accompanying drawings, which is set forth hereinafter. When it is considered that detailed description on related art may obscure the points of the present invention, the description will not be provided herein. Hereinafter, preferred embodiments of the present invention will be described with reference to the accompanying drawings.

Following description exemplifies only the principles of the present invention. Even if they are not described or illustrated clearly in the present specification, one of ordinary skill in the art can embody the principles of the present invention and invent various apparatuses within the concept and scope of the present invention. The use of the conditional terms and embodiments presented in the present specification are intended only to make the concept of the present invention understood, and they are not limited to the embodiments and conditions mentioned in the specification.

In addition, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures.

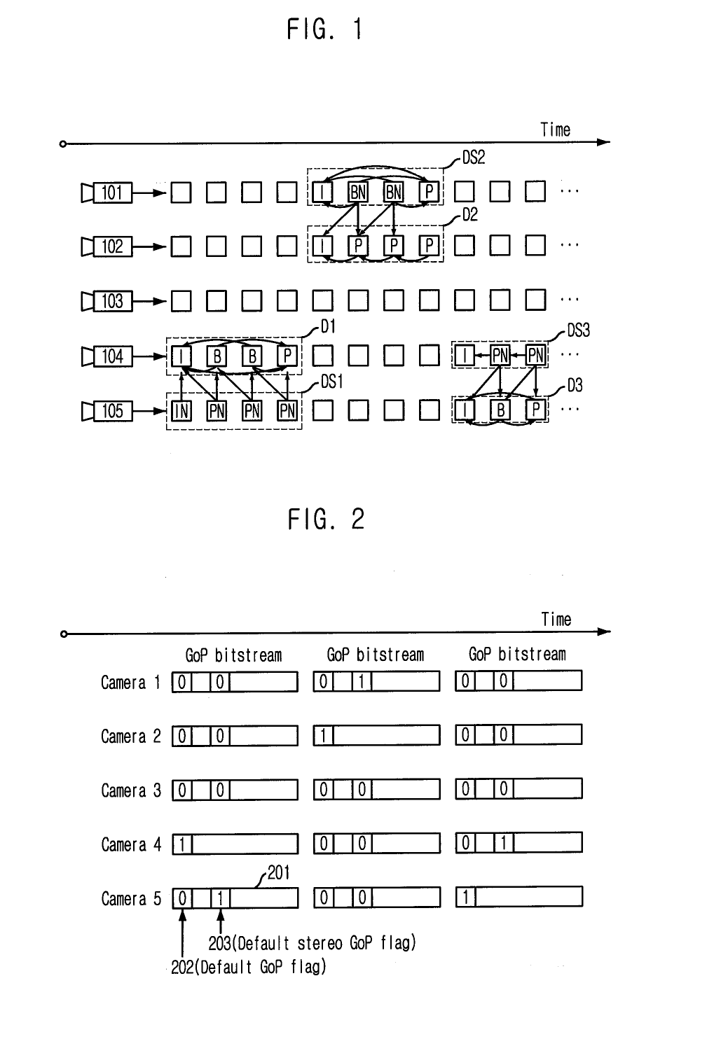

FIG. 1 is a view illustrating a method of compressing video streams from multiple view positions in accordance with an embodiment of the present invention. The drawing shows an embodiment that video streams generated from five cameras 101 to 105 are compressed. Herein, video streams signify video signals or Group of Pictures (GoP) generated from each camera.

Referring to FIG. 1, a default view is determined among the five cameras 101 to 105 in the present embodiment at each time duration, which is predetermined.

The default view may be determined arbitrarily by a content producer or it may be inputted by the user according to embodiments. In the present embodiment, it is assumed that the default view is determined arbitrarily by the content producer. The content producer may fix a default view or set up to optionally select and change one among a plurality of views according to the characteristics of each content. Thus, the default view is not fixed to one of a single camera but hops among the views according to time.

Video stream of a camera selected as a base camera for providing a default view at predetermined time becomes a default GoP D1, D2 or D3, and only the default GoP is referred to for encoding/decoding, and video streams from the other adjacent cameras are not used.

Also, a ‘default stereo GoP’ DS1, DS2 or DS3 is defined to include video streams encoded with reference to the default GoP among video streams of the adjacent cameras at the same time duration to create stereo video signals. A stereo video playing apparatus decodes and reconstructs video signals only with the default GoP D1, D2 or D3 and default stereo GoP DS1, DS2 or DS3 corresponding to the default GoP.

As shown in FIG. 1, a default stereo view signifies a view position where the default GoP is referred to at a predetermined time duration. Thus, the default stereo view may be selected and changed based on information inputted by the user or changed by the content producer based on time according to how an embodiment is formed.

In FIG. 1, a video I refers to an intra frame, and P denotes a prediction frame. A video B is a bidirectional frame, and IN, BN and PN denote intra-neighbor, bidirectional-neighbor, and predicted-neighbor frame, respectively. Herein, “neighbor” is a video that refers to adjacent video frames. Each of the other unmarked frames may be any one among I, B, P, IN, BN, and PN. Also, the arrow mark indicates a video that is referred to. In other words, video B and video P of a default GoP D1 are encoded with reference to the video I in the first time duration.

FIG. 2 is a view showing a GoP bitstream created by encoding and compressing video streams from multiple view positions.

Referring to FIG. 2, each bitstream of each GoP has a bit indicating whether the bitstream is of a default view. In other words, bitstream 201 of each GoP includes a default GoP flag 202 for indicating whether the bitstream is of a default GoP. For example, when the flag value of the default GoP is ‘1,’ the GoP is determined as a default GoP. Also, each bitstream of each GoP further includes a flag for identifying whether it is a default stereo GoP, e.g., a default stereo GoP flag 203 of the GoP 201. Of course, when bitstream is of the default GoP, the default stereo GoP flag may not have a value. Although the present invention is not limited thereto, when the default stereo GoP flag has a value of ‘1,’ the GoP is a default stereo GoP.

Consequently, the default stereo GoP is a GoP that refers to the default GoP among GoPs which are not the default GoP.

The following describes a default view processing apparatus for transmitting video data to a mono video playing apparatus, and then a default stereo view processing apparatus for transmitting video data to a stereo video playing apparatus.

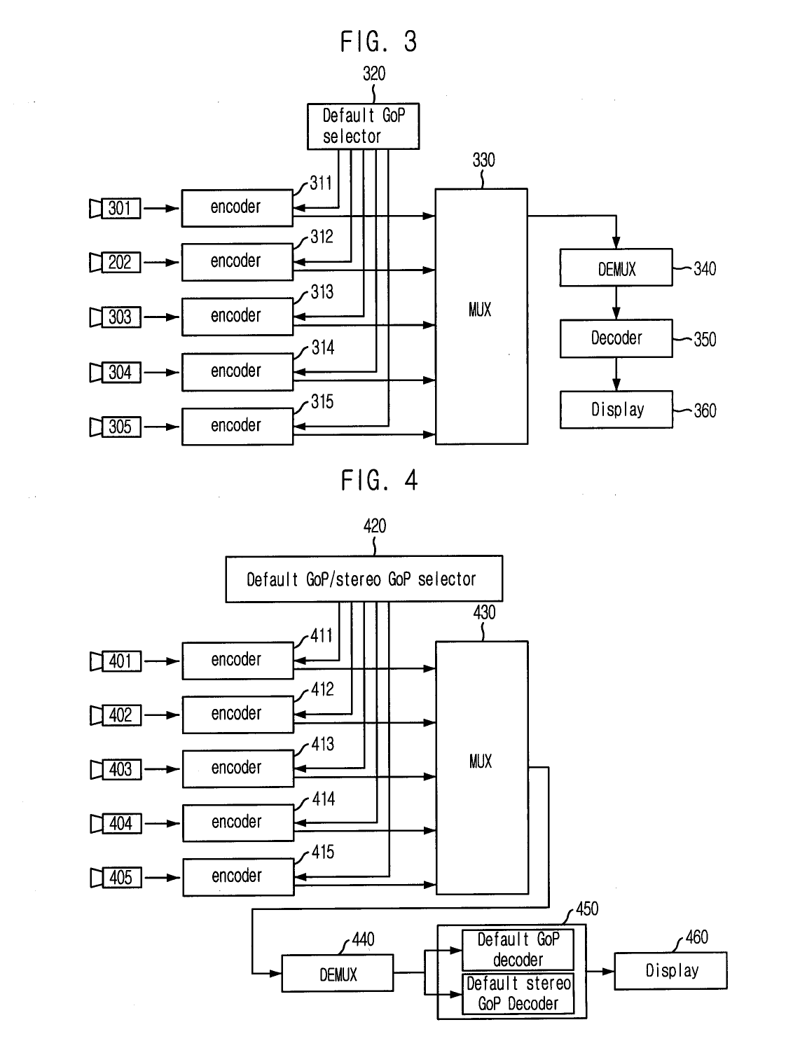

FIG. 3 is a block view showing structures of a default view processing apparatus and a mono video playing apparatus in accordance with an embodiment of the present invention.

A transmitting part of the multiple camera system, i.e., an encoding apparatus, includes a plurality of cameras 301 to 305, encoders 311 to 315 connected to the cameras, respectively, a default GoP selector 320, and a multiplexer 330. A receiving part of the multiple camera system, i.e., a decoding apparatus, includes a demultiplexer 340, a decoder 350, and a display 360. Herein, the receiving part composed of the demultiplexer 340, the decoder 350, and the display 360, corresponds to the mono video playing apparatus. Of course, the transmitting and receiving parts of the multiple camera system may further include a constituent element for transmitting/receiving signals and/or the other constituent elements.

Referring to FIG. 3, video signals created in the cameras 301 to 305, i.e., the video signal input devices, are encoded in a predetermined video compression scheme in the respective encoders 311 to 315. That is, video signals of the camera 301 are encoded with the encoder 311. The video compression scheme used in the respective encoders may be based on MPEG-1/2/4 or H.261/263/264. To reflect a default view determined by the content producer, the default GoP selector 320 provides default GoP information determined for each time duration to the encoders 311 to 315. The encoders 411 to 415 mark in the default GoP flag 202 of a GoP bitstream according to the default GoP information as described above. Herein, the default GoP is encoded with no reference to video inputted through the adjacent cameras or compressed/decoded video data.

Bitstreams of multiple GoPs generated in the respective encoders 311 to 315 are multiplexed in the multiplexer 330 by using a multiple video storing method. When video signals from the multiplexed bitstreams need to be transmitted to the mono video playing apparatus, the multiplexer 330 outputs only the bitstreams of the default GoP according to time. The outputted default GoP bitstreams are transmitted to the receiving part through a transmission channel (not shown).

The mono video playing apparatus is composed of the demultiplexer 340 for demultiplexing received signals, the decoder 350 for decoding only the default GoP among the output signals of the demultiplexer 340, and the display 360 for showing decoded video streams.

Content producers can set up a default video based on time in the multiple camera system, too, by using the aforementioned method.

FIG. 4 is a block view illustrating structures of a stereo video processing apparatus and a stereo video playing apparatus in accordance with an embodiment of the present invention. A transmitting part of the multiple camera system includes a plurality of cameras 401 to 405, encoders 411 to 415 connected to the cameras, respectively, a default GoP/stereo GoP selector 420, and a multiplexer 430. A receiving part of the multiple camera system includes a demultiplexer 440, a decoder 450, and a display 460. Herein, the receiving part of the multiple camera system composed of the demultiplexer 440, the decoder 450, and the display 460 corresponds to the stereo video playing apparatus.

Referring to FIG. 4, video signals created in the cameras 401 to 405, i.e., video signal input devices, are encoded in the respective encoders 411 to 415 by using a predetermined video compression scheme.

To reflect a default view and a default stereo view which are determined based on the information transmitted from the user or the content producer in accordance with the embodiment, the default GoP/stereo GoP selector 420 provides default GoP information and default stereo GoP information, which are determined on a predetermined time basis, to the encoders 411 to 415. The encoders 411 to 415 mark in the default GoP flag 202 and the default stereo GoP flag 203 of a GoP bitstream as described above based on the default GoP information and the default stereo GoP information. Herein, the default GoP is encoded with no reference to video inputted from the adjacent cameras or compressed/decoded video data, and the default stereo GoP is encoded by referring to only the default GoP.

Bitstreams of multiple GoPs generated in the respective encoders 411 to 415 are multiplexed in the multiplexer 430 by using a multiple video storing method. When video signals from the multiplexed bitstreams need to be transmitted to the stereo video playing apparatus, the multiplexer 330 outputs only the bitstreams of the default GoP and the default stereo GoP according to time. The outputted default GoP bitstreams and the default stereo GoP bitstreams are transmitted to the receiving part through a transmission channel (not shown). The default GoP bitstreams and the default stereo GoP bitstreams may be packetized in diverse methods and transmitted according to a conventional multi-view video signal transmission method.

The stereo video playing apparatus is composed of the demultiplexer 440 for demultiplexing received signals, the decoder 450 for decoding only the default GoP and the default stereo GoP among the output signals of the demultiplexer 440, and the display 460 for showing decoded stereo video streams. As illustrated in FIG. 4, the decoder 450 may be composed of a default GoP decoder and a default stereo GoP decoder. The display 460 is a stereo output device for displaying stereo video.

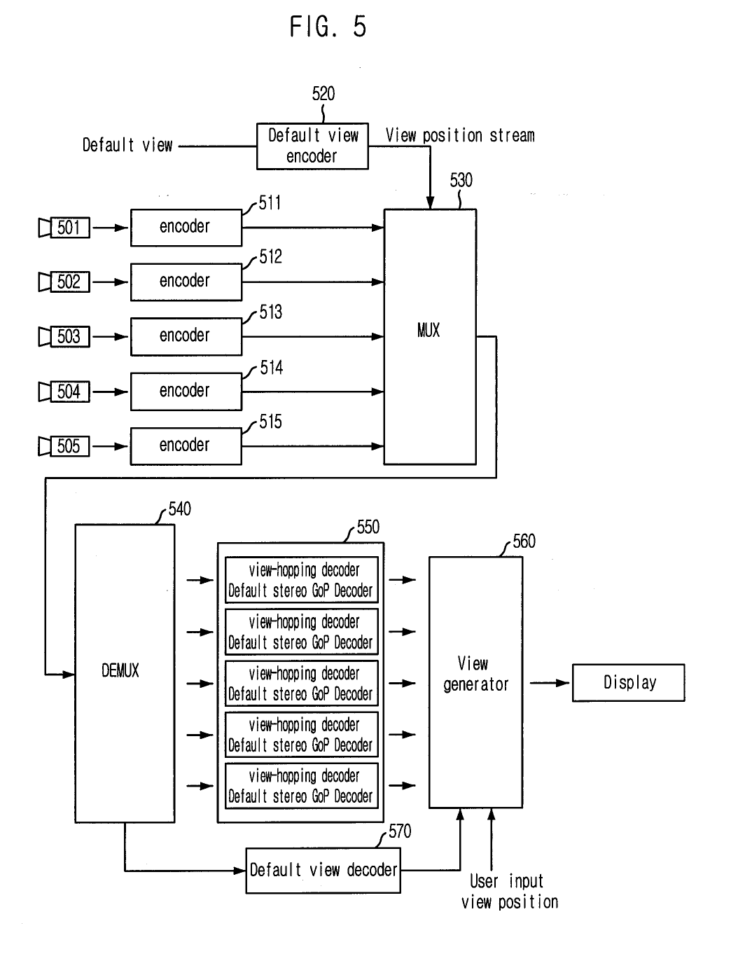

FIG. 5 is a block view describing a view-hopping video processing apparatus and a view-hopping video playing apparatus in accordance with an embodiment of the present invention.

A transmitting part of the multiple camera system includes a plurality of cameras 501 to 505, encoders 511 to 515 connected to the cameras, respectively, a default view encoder 520, and a multiplexer 530. A receiving part of the multiple camera system includes a demultiplexer 540, a decoder 550, a view generator 560, a default view decoder 570, and a display 580. Herein, the receiving part of the multiple camera system composed of the demultiplexer 540, the decoder 550, the view generator 560, the default view decoder 570, and the display 580 corresponds to the view-hopping video playing apparatus.

Basically, the view-hopping video playing apparatus decodes and displays video streams of a view position selected by a user, i.e., a viewer, when the user requests the desired view position. In the embodiment described in FIG. 5, the content producer transmits default view position information he/she wants and, when the user does not determine a specific view position, a view is selected based on the default view position and video signals are displayed.

Referring to FIG. 5, video signals generated in the respective cameras 501 to 505, i.e., video signal input devices, are encoded in the encoders 511 to 515 by using a predetermined video compression scheme.

To reflect the default view position information determined by the content producer along with video signals, the default view encoder 520 encodes the default view position information determined by the content producer and inputs the default view position information to the multiplexer 530. The multiplexer 530 multiplexes bitstreams of multiple GoPs generated in the encoders 511 to 515 by using a general multi-view video storing method. Also, the multiplexer 530 multiplexes the view position stream generated in the default view encoder 520 with the multiple GoP bitstreams and outputs the multiplexed bitstreams. The outputted view position stream and the multiple GoP bitstreams are transmitted to the receiving part through a transmission channel (not shown). The view position stream and the multiple GoP bitstreams may be packetized in diverse methods and transmitted according to a conventional multi-view video signal transmission method. For example, they may be packetized in the form of a header, which includes view position information and other additional information, and a payload, which includes GoP bitstreams, and then transmitted to the receiving part.

The view-hopping video playing apparatus is composed of the demultiplexer 540 for demultiplexing received signals and outputting GoP bitstreams and view position stream, the decoder 550 for decoding the demultiplexed GoP bitstreams according to each view position, a default view decoder 570 decoding the view position stream and provides the decoded view position stream to the view generator 560, and the display 580 for showing view-hopping video streams. The view generator 560 generates a view according to user setup information when the user determines a view position for oneself, and transmits corresponding video stream to the display 580. When the user does not determine any view position, the view generator 560 generates a view of a default view position, and transmits corresponding video stream of the default view position to the display 580.

As described above, the method of the present invention can be realized as a program and stored in a computer-readable recording medium, such as CD-ROM, RAM, ROM, floppy disks, hard disks, magneto-optical disks and the like. Since the procedure can be easily implemented by those skilled in the art to which the present invention pertains, further description will not be provided herein.

While the present invention has been described with respect to certain preferred embodiments, it will be apparent to those skilled in the art that various changes and modifications may be made without departing from the scope of the invention as defined in the following claims.

What is claimed is:

1. An encoding apparatus for a multiple camera system, comprising:
an encoder for receiving video signals of multiple view positions, and encoding the video signals based on a predetermined default Group of Pictures (GoP);
a default GoP selector for providing the default GoP information to the encoder; and
a multiplexer for multiplexing the encoded video signals and sequentially outputting only the default GoP.

2. The encoding apparatus as recited in claim 1, wherein the default GoP is encoded with no reference to video signals of another view position.

3. The encoding apparatus as recited in claim 1, wherein the default GoP is changed with a GoP of another view position for each predetermined time duration.

4. The encoding apparatus as recited in claim 1, wherein the GoP bitstreams outputted from the encoder include a flag for indicating whether the GoP bitstreams are of a default view.

5. The encoding apparatus as recited in claim 4, wherein the multiplexer sequentially outputs only the default GoP based on a value of the flag.

6. A decoding apparatus for a multiple camera system, comprising:
a receiver for sequentially receiving encoded default GoP with no reference to video signals of another view position;
a decoder for decoding the received signals; and
a display for showing the decoded video signals.

7. The decoding apparatus as recited in claim 6, wherein the default GoP is changed with video signals of another view position for each predetermined time duration.

8. A multiple camera system, comprising:
an encoder for receiving video signals of multiple view positions, and encoding the multi-view video signals based on predetermined default Group of Pictures (GoP) information;
a GoP selector for providing the default GoP information to the encoder;
a multiplexer for multiplexing the encoded video signals and sequentially outputting only a default GoP; and
a decoder for receiving, decoding, and displaying the sequentially outputted default GoP.

9. An encoding apparatus for a multiple camera system, comprising:
an encoder for receiving video signals of multiple view positions, and encoding the video signals based on a predetermined default Group of Pictures (GoP) and a default stereo GoP;
a GoP selector for providing the predetermined default GoP information and the default stereo GoP information to the encoder; and
a multiplexer for multiplexing the encoded video signals and sequentially outputting only a default GoP and a default stereo GoP corresponding to the default GoP.

10. The encoding apparatus as recited in claim 9, wherein the default GoP is encoded with no reference to video signals of another view position.

11. The encoding apparatus as recited in claim 9, wherein the default GoP is changed with a GoP of another view position for each predetermined time duration.

12. The encoding apparatus as recited in claim 9, wherein the default stereo GoP is encoded with reference to the default GoP of the same time duration.

13. The encoding apparatus as recited in claim 9, wherein the GoP bitstreams outputted to the encoder includes a flag for indicating any one between a default view and a default stereo view.

14. A decoding apparatus for a multiple camera system, comprising:
a receiver for sequentially receiving a default Group of Pictures (GoP) encoded with no reference to video signals of another view position and a default stereo GoP of the same time duration which refers to the default GoP;
a decoder for decoding the received signals; and
a display for showing stereo video signals based on the decoded signals.

15. The decoding apparatus as recited in claim 14, wherein the default GoP is changed with a GoP of another view position for each predetermined time duration.

16. The decoding apparatus as recited in claim 14, wherein the decoder decodes the default stereo GoP with reference to the default GoP.

17. A multiple camera system, comprising:
an encoder for receiving video signals of multiple view positions, and encoding the multi-view video signals based on predetermined default Group of Pictures (GoP) information and a predetermined default stereo GoP information;
a default GoP selector for providing the default GoP information and the default stereo GoP information to the encoder;
a multiplexer for multiplexing the encoded video signals and sequentially outputting only a default GoP and a default stereo GoP corresponding to the default GoP; and
a decoder for receiving and decoding the multiplexed output signals, and displaying stereo video signals based on the decoded signals.

18. A multiple camera system, comprising:
an encoder for receiving and encoding video signals of multiple view positions;
a default view encoder for encoding predetermined default view information;
a multiplexer for multiplexing the encoded multi-view video signals and the encoded default view information, and outputting multiplexed signals; and
a view-hopping video playing apparatus for displaying the video signals based on the default view information.

19. The multiple camera system as recited in claim 18, wherein the default view is changed with a view of another view position for each predetermined time duration.

20. An encoding method for a multiple camera system, comprising the steps of:
a) providing predetermined default Group of Pictures (GoP) information;
b) receiving video signals of multiple view positions, and encoding the video signals based on the default GoP information; and
c) multiplexing the encoded video signals, and sequentially outputting only a default GoP.

21. The encoding method as recited in claim 20, wherein the default GoP is encoded with no reference to video signals of another view position.

22. The encoding method as recited in claim 20, wherein the default GoP is changed with a GoP of another view position for each predetermined time duration.

23. The encoding method as recited in claim 20, wherein the encoded GoP bitstreams include a flag for indicating whether the encoded GoP bitstreams are of a default view.

24. A decoding method for a multiple camera system, comprising the steps of:
a) sequentially receiving a default Group of Pictures (GoP) encoded with no reference to video signals of another view point;
b) decoding the received signals; and
c) displaying the decoded video signals.

25. The decoding method as recited in claim 24, wherein the default GoP is changed with video signals of another view position for each predetermined time duration.

26. An encoding method for a multiple camera system, comprising the steps of:
a) providing predetermined default Group of Pictures (GoP) information and default stereo GoP information to an encoder;
b) receiving video signals of multiple view positions, and encoding the video signals based on the default GoP information and the default stereo GoP information; and
c) multiplexing the encoded video signals, and sequentially outputting only a default GoP and a default stereo GoP corresponding to the default GoP.

27. The encoding method as recited in claim 26, wherein the default GoP is encoded with no reference to video signals of another view position.

28. The encoding method as recited in claim 26, wherein the default GoP is changed with a GoP of another view position for each predetermined time duration.

29. The encoding method as recited in claim 26, wherein the default stereo GoP is encoded with reference to the default GoP of the same time duration.

30. The encoding method as recited in claim 26, wherein the encoded GoP bitstreams include a flag for indicating whether the encoded GoP bitstreams are of a default view or of a default stereo view.

31. A decoding method for a multiple camera system, comprising the steps of:
a) sequentially receiving a default Group of Pictures (GoP) encoded with no reference to video signals of another view position, and a default stereo GoP of the same time duration which refers to the default GoP;
b) decoding the received signals; and
c) displaying stereo video signals based on the decoded signals.

32. The decoding method as recited in claim 31, wherein the default GoP is changed with a GoP of another view position for each predetermined time duration.

33. The decoding method as recited in claim 31, wherein the default stereo GoP is decoded with reference to the default GoP in the decoding step b).

34. A method for providing a default view in a multiple camera system, comprising the steps of:
a) receiving and encoding video signals of multiple view positions;
b) encoding predetermined default view information;
c) multiplexing and outputting the encoded multi-view video signals and the default view information; and
d) displaying the video signals based on the default view information.
